(19) United States
(12) Patent Application Publication
(10) Pub. No.: US 2024/0231123 A1
(43) Pub. Date: Jul. 11, 2024

(54) PAIR OF SPECTACLES COMPRISING LONGITUDINALLY OFFSET HINGES

(71) Applicants: Alain MIKLITARIAN, Boissy Sans Avoir (FR); Richard CHENE, Neuilly (FR); Dominique DELAMOUR, Les Mesnuls (FR)

(72) Inventors: Alain MIKLITARIAN, Boissy Sans Avoir (FR); Richard CHENE, Neuilly (FR); Dominique DELAMOUR, Les Mesnuls (FR)

(21) Appl. No.: 18/569,788

(22) PCT Filed: Jun. 23, 2022
(86) PCT No.: PCT/EP2022/067223

§ 371 Date: Dec. 13, 2023

(30) Foreign Application Priority Data
Jun. 23, 2021 (FR) FR2106721
Jun. 28, 2021 (WO) PCT/EP2021/067752

(51) Int. Cl. G02C 5/14; G02C 5/22

(52) U.S. Cl. CPC G02C 5/146; G02C 5/22

(57) ABSTRACT

The invention relates to a pair of spectacles extending along a first longitudinal axis from the rear to the front, comprising a front face, a first tenon, a second tenon, a first temple and a second temple, which are respectively connected to the first tenon and the second tenon via a first hinge and a second hinge, the first tenon being shorter than the second tenon such that the longitudinal positions of the hinges are different in order to limit the risk of deformation of the front face as a result of a longitudinal compressive load.

### TECHNICAL FIELD

The present invention relates to the field of pairs of spectacles.

In a known manner, with reference to FIG. 1, a pair of spectacles 100 comprises lenses VA. The lenses VA may be of different natures, in particular, viewing, fantasy, temporary, presentation lenses, etc. In this example, the pair of spectacles is presented in a reference framework (X, Y, Z) in which the X-axis extends longitudinally from the front to the rear, the Y-axis extends laterally from the left to the right, and the Z-axis extends vertically from the bottom to the top.

The pair of spectacles 100 comprises a front face 110, extending globally in the plane (Y, Z), comprising two lenses VA as well as a first tenon 111 and a second tenon 112 that are connected to the front face 110.

The pair of spectacles 100 further comprises a right temple 121 and a left temple 122 which are respectively connected to the right tenon 111 and the left tenon 112 via a right hinge 131 and a left hinge 132. Thus, each lateral temple 121, 122 can move between a folded storage position in which the lateral temple 121, 122 is substantially aligned with the front face 110 (see FIG. 1) and an unfolded position of use in which the lateral temple 121, 122 is substantially orthogonal to the front face 110. When the pair of spectacles 100 is folded, the temples 121, 122 are positioned one behind the other with respect to the X-axis. In a known manner, a pair of spectacles 100 is symmetrical such that the comfort of the wearer is identical on each side of the wearer's face when wearing the pair of spectacles PA.

To protect a pair of spectacles PA, it is known to store the latter in a case ET as shown schematically in FIG. 2. When stored, a case ET may be compressed into a jacket or a bag. During this compression, a longitudinal compressive force F is applied to the temples 121, 122 in the folded position. More precisely, a longitudinal compressive force is applied according to a pressure point PRESS on the rearmost lateral temple (here the left temple 122) which is transmitted to the frontmost lateral temple (here the right temple 121) given that the temples 121, 122 are superimposed. The longitudinal compressive force F is then transmitted to the tenons 111, 112 which deform the front face 110. The front face 110 is then warped and no longer has its original shape. Such a deformation modifies the position of the lenses in relation to the gaze of the wearer, degrading the optical correction provided, which is a source of ophthalmic discomfort for the wearer. The deformation also has a certain esthetic disadvantage. In addition, the axes of the hinges 131, 132 may also be deformed, which disturbs the closure of the temples 121, 122. This contact between the temples, also known as “slewing”, has many drawbacks. The probability of an undesired deformation is furthermore greater in high heat given that the material forming the frame is sensitive to high temperatures, in particular an acetate frame.

This deformation may occur when the pair of spectacles PA is stored in any type of case ET (soft or rigid). The deformation may also occur when closing the lid of the case ET which compresses the pair of spectacles PA. Such compressions also apply when the pair of spectacles PA is not stored in a case ET but, for example, slipped into a garment. An immediate solution to resolve this drawback would be to make the pair of spectacles PA very rigid to avoid its deformation, but this increases its volume and affects the comfort of the wearer. Such a solution cannot therefore be retained.

Incidentally, in the prior art, several solutions are known for folding the temples making it possible to limit the bulk of a pair of spectacles, but these solutions do not make it possible to limit the deformation of the front face. In particular, a pair of spectacles is known, by patent application U.S. Pat. No. 8,192,017B2, of which the lateral temples are hinged with the front face with a vertical displacement play so as to allow the temples to be positioned one above the other in the storage position. The superposition of the temples is avoided, but the longitudinal compressive force is nevertheless transmitted independently by each of the lateral temples to the front face which deforms.

There is thus a need for a novel pair of spectacles, the front face of which is unlikely to deform, in particular when the pair of spectacles is compressed longitudinally. Another objective of the present invention is not to impact the cost of manufacturing a pair of spectacles.

The patent application US2013/0044287A which presents a pair of spectacles that can be used as a bookmark is known in the prior art. The temples of the pair of spectacles are rectilinear and narrow so that the book can be closed without twisting the temple of the spectacles. Further, the lenses must be narrow so that they do not extend outside the binding of a book.

The patent application U.S. Pat. No. 5,875,016 which presents a pair of spectacles that makes it possible to reduce the appearance of fogging and to limit discomfort with respect to wind during snowboarding is known in the prior art. In order to improve wind protection, the front face is curved and asymmetrical so as to provide reinforced protection on one side of the front face.

### DESCRIPTION OF THE INVENTION

To this end, the invention relates to a pair of spectacles, extending along a first longitudinal axis from the rear to the front, comprising:
a front face comprising two lenses,
a first tenon and a second tenon which are connected to the front face,
a first temple and a second temple which are respectively connected to the first tenon and the second tenon via a first hinge and a second hinge.

The invention is remarkable in that the longitudinal positions of the hinges are different in order to limit the risk of deformation of the front face as a result of a longitudinal compressive force.

Thus, advantageously, the two temples are folded in different planes, spaced apart from each other so as to limit or avoid the transmission of a longitudinal compressive force between two temples. The front face thus is not subjected to loads at several points and does not deform even if its rigidity is low. The second temple acts as a mechanical damper and absorbs all the compressive forces. Slewing forces, present in the prior art, are considerably reduced.

Advantageously, the service life of the pair of spectacles is increased and the front face may be thinned to decrease its rigidity. A thinned front face makes it possible to create pairs of spectacles with lower stresses, in particular originally shaped temples. In folded position, the pair of spectacles is secured in its case. Advantageously, the invention applies both to thick and thin front faces by making it possible to avoid deformation.

The positioning of the lenses is long lasting over time, improving the comfort of the wearer. From an industrial point of view, it suffices to modify the length of the tenons, which does not incur any additional cost.

By proposing a pair of spectacles having an asymmetrical structure, the Claimant overcomes a prejudice widespread in optics which imposes that a pair of spectacles has a symmetrical structure to ensure the comfort of the wearer when wearing the pair of spectacles and to ensure an esthetic appearance. Thanks to the invention, the pair of spectacles retains its esthetic appearance in the unfolded position while being resistant to deformation in the folded position. The functionalities of the pair of spectacles are improved compared to the prior art.

Preferably, the first tenon is shorter than the second tenon so that the longitudinal positions of the hinges are different in order to limit the risk of deformation of the front face.

According to one aspect, the first temple is longer than the second temple. According to a preferred aspect, the assembly of the first tenon and the first temple has the same length as the assembly of the second tenon and the second temple. Thus, when wearing the pair of spectacles, the pair of spectacles has a symmetrical esthetic appearance despite its asymmetrical structure.

According to another aspect, the first temple and the second temple have the same length. Preferably, the first temple and the second temple are directly in contact with the front face. Advantageously, the tenons are offset with respect to the temples and the hinges are not in the alignment of the temples in the unfolded position. The temples are identical, only the tenons being different.

Preferably, the first temple having a determined thickness, the gap between the longitudinal positions of the hinges is greater than the determined thickness so as to avoid contact between the first temple and the second temple. Advantageously, the gap is determined as a function of the thickness of the first temple in order to avoid any contact. The spacing may thus be individually adapted to each pair of spectacles.

Preferably, the gap between the longitudinal positions of the hinges is comprised between 0.5 mm and 10 mm, preferably comprised between 1 mm and 7 mm, preferably still comprised between 2 mm and 5 mm. Such a gap makes it possible to make the pair of spectacles robust to deformations while limiting it longitudinal bulk.

According to a preferred aspect, the first temple is the right temple. Thus, a pair of spectacles may be folded intuitively by a right-handed person.

Preferably, the first hinge and/or the second hinge is in the form of a mechanism, comprising a hinging axis, which is connected on the one hand to the front face and on the other hand to the first temple and/or the second temple.

The invention also relates to a method of folding the temples of a pair of spectacles as presented previously, the temples being in the unfolded position, the method comprising:
A step of folding the first temple against the front face then,
A step of folding the second temple, the second temple being distant from the first temple in the folded position.

Alternatively, the invention relates to a pair of spectacles, extending along a first longitudinal axis from the rear to the front, comprising:
a front face comprising two lenses,
a first tenon and a second tenon which are connected to the front face,
a first temple and a second temple which are respectively connected to the first tenon and the second tenon via a first hinge and a second hinge.

The invention is remarkable in that the first tenon is shorter than the second tenon so that the longitudinal positions of the hinges are different in order to limit the risk of deformation of the front face as a result of a longitudinal compressive force.

### DESCRIPTION OF THE FIGURES

The invention will be better understood upon reading the following description, given as an example, and referring to the following figures, given as non-limiting examples, in which identical references are given to similar objects.

FIG. 1 is a schematic representation of a pair of spectacles according to the prior art.

FIG. 2 is a schematic representation of the pair of spectacles of FIG. 1 in the stored position in a case during a longitudinal compression.

FIG. 3 is a schematic representation of a pair of spectacles according to one embodiment of the invention in folded position.

FIG. 4 is a schematic representation of the pair of spectacles of FIG. 3 when folded.

FIG. 5 is a schematic top representation of the pair of spectacles of FIG. 3.

FIG. 6 is a schematic representation of the pair of spectacles of FIG. 3 in stored position in a case during a longitudinal compression.

FIG. 7 is a schematic representation of a pair of spectacles of the “rimless-clip on” type in the folded position.

FIG. 8 is a schematic representation of a pair of spectacles of the “rimless-clip on” type in the unfolded position.

FIG. 9 is an isometric representation of a pair of spectacles of the “rimless-clip on” type in the folded position.

FIG. 10 is an isometric representation of a pair of spectacles of the “rimless-clip on” type in the unfolded position.

FIG. 11 is a schematic representation of a pair of spectacles according to another embodiment in the folded position.

FIG. 12 is a schematic representation of a pair of spectacles according to another embodiment in the unfolded position.

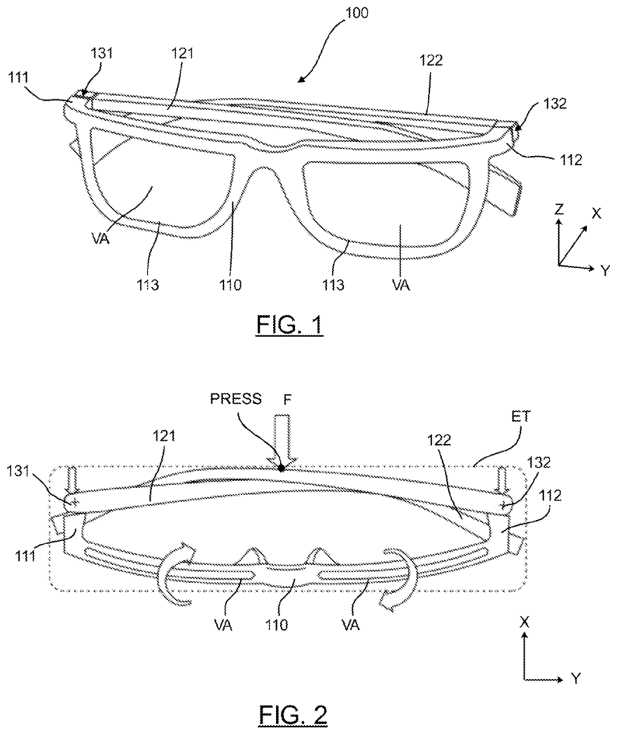

It should be noted that the figures set out the invention in detail in order to implement the invention, said figures may of course be used to better define the invention where applicable.

### DETAILED DESCRIPTION OF THE INVENTION

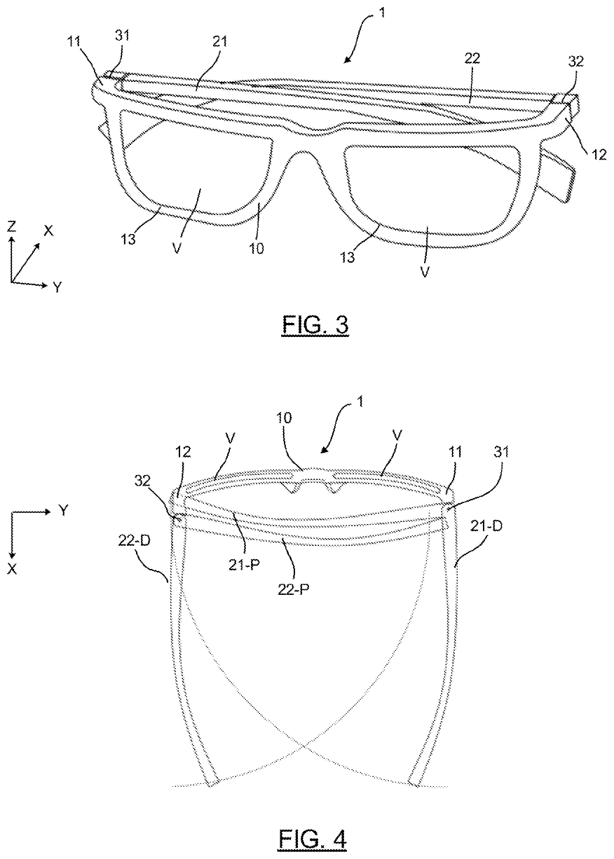

With reference to FIG. 3, a pair of spectacles P according to one embodiment of the invention is represented.

In this example, the pair of spectacles P is presented in a reference framework (X, Y, Z) in which the X-axis extends longitudinally from the front to the rear, the Y-axis extends laterally from the left to the right and the Z-axis extends vertically from the bottom to the top.

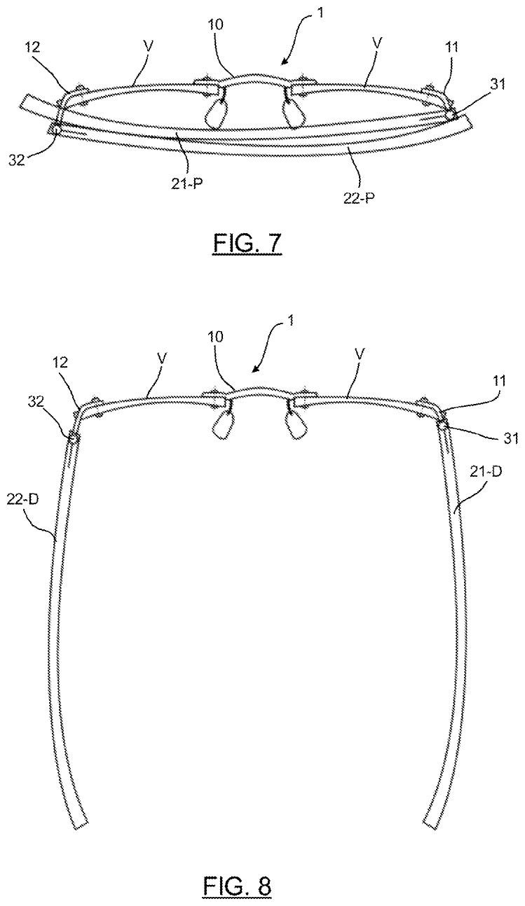

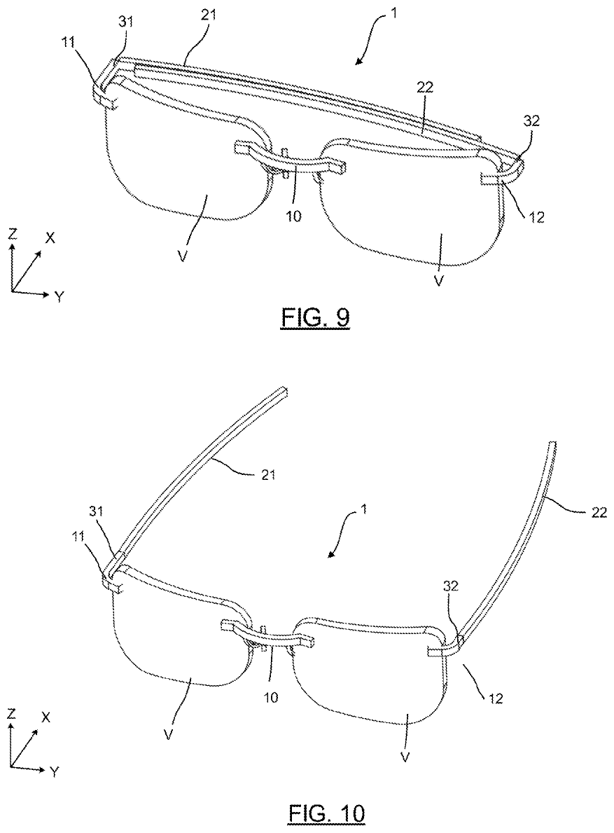

As illustrated in FIG. 3, the pair of spectacles 1 comprises a front face 10 comprising two lenses V. The front face 10 may be of different natures, for example, surrounded with openings 13 for the lenses V (FIG. 3), rimless-clip on (FIGS. 7 to 10) or other. The front face 10 may thus be both one-piece and modular. Similarly, the front face 10 may be made of various materials (plastic, metal, etc.), in particular, acetate.

The front side is symmetrical, i.e. it has a traditional symmetrical structure. The symmetrical character of the front face is defined without the tenons. Preferably, the front face is substantially flat, i.e., its thickness along the X-axis is less than 30 mm, preferably less than 20 mm.

The pair of spectacles 1 further comprises a first tenon 11 and a second tenon 12 which are connected to the front face 10. In this example, the first tenon 11 is a right lateral tenon while the second tenon 12 is a left lateral tenon. The front face 10 has a pantoscopic angle with respect to the plane (Y, Z) which allows the lenses V to be positioned optimally. The lenses V may be of different natures, in particular, viewing, fantasy, sun, temporary, presentation lenses, etc.

Still with reference to FIG. 3, the pair of spectacles 1 further comprises a first temple 21 (here a right temple) and a second temple 22 (here a left temple) which are respectively connected to the first tenon 11 and the second tenon 12 via a first hinge 31 and a second hinge 32. Thanks to its hinge 31, 32, as illustrated in FIG. 4, each temple 21, 22 can move between an unfolded position D in which the temple 21, 22 extends along the longitudinal X-axis and a folded position P in which the temple 21, 22 extends laterally along the Y-axis.

The first temple 21 and the second temple 22 each have a curvilinear portion to contour the wearer's ear in order to provide comfort similar to a traditional pair of spectacles. In particular, the curvilinear portion is configured to pass in proximity to the temporal bone to reach the outer/upper part of the ear.

A tenon is taken to mean an element that connects the front face 10 to the hinge that allows the closure of a temple, the tenon being able to be a part added onto the front face 10 (i.e. subsequently attached onto the front face 10), or a part made of material of the front face 10 (i.e. formed at the same time as the front face 10). The tenon could be independent or integrated into the hinge (pivot hinge, mechanism, garnet hinge or other).

According to the invention, the longitudinal positions of the hinges 31, 32 are different in order to limit the risk of deformation of the front face 10 as a result of a longitudinal compressive force. Preferably, the first tenon 11 is shorter than the second tenon 12 such that the longitudinal positions of the hinges 31, 32 are different in order to limit the risk of deformation of the front face 10, in particular, of the pantoscopic angle.

The difference in length, along the longitudinal X-axis, between the tenons 11, 12 is advantageous given that it allows each temple 21, 22 to be, in the folded position, in a different plane than the other temple 21, 22. In other words, in the folded position, the temples 21, 22 have only little or no contact as illustrated in FIG. 4. Advantageously, the pantoscopic angle of the front face 10 is protected.

Preferably, the hinges 31, 32 are in the form of a pivot hinge having the same angular range of rotation. Preferably, each hinge comprises a closure stop so as to limit the closure angle and reduce contact between the temples to reduce the transmission of forces.

In this example, the hinges 31, 32 allow a hinging in the same horizontal plane but it goes without saying that they could be vertically offset, i.e., respectively hinge in two horizontal planes offset vertically.

According to one aspect of the invention, the hinges 31, 32 are non-adjustable, i.e., fixed.

According to one aspect of the invention, the first hinge 31 and/or the second hinge 32 is in the form of a mechanism, comprising a hinging axis, which is connected on the one hand to the front face 10 and on the other hand to the first temple 21 and/or the second temple 22. Thus, a mechanical hinge may notably be mounted in a staggered manner on the front face 10. According to another aspect of the invention, the first hinge 31 and/or the second hinge 32 is in the form of a simple rod/screw forming the hinging axis.

In this example, a hinge is referred to as a temple hinge, i.e., configured to allow a fold of a temple 21/22 with respect to the front face 10.

In the present case, given that the first tenon 11 is shorter, the first temple 21 must be folded before the second temple 22 to avoid any contact. The second temple 22 is thus positioned at a distance behind the first temple 21 as illustrated in FIG. 4. Advantageously, as will be presented later, the second temple 22 fulfills a damper function by avoiding transmitting in its entirety any longitudinal compressive force F to the first temple 21. As a result, any longitudinal compressive force F is no longer transmitted to various points of the front face 10 which thus avoids deformation.

The tenons 11, 12 and the temples 21, 22 of the pair of spectacles 1 will now be presented in detail.

According to one aspect of the invention, the first temple 21 is longer than the second temple 22 in order to compensate for the fact that the first tenon 11 is shorter than the second tenon 12. In this example, the assembly of the first tenon 11 and the first temple 21 has the same length as the assembly of the second tenon 12 and the second temple 22. Thus, in the worn position, the pair of spectacles 1 is symmetrical, which ensures functionalities similar to the prior art and optimal comfort for the wearer.

In this example, the tenons 11, 12 are aligned with the temples 21, 22 in the unfolded position. In other words, the temples 21, 22 are directly in contact with the tenons 11, 12 in the unfolded position and the temples 21, 22 are not in contact with the front face 10.

Preferably, each temple 21, 22 is free of internal hinging. Its manufacture is advantageously traditional, only its length needs to be adapted. Even more preferably, the pair of spectacles 1 comprises only two hinges 31, 32, one associated with each temple 21, 22.

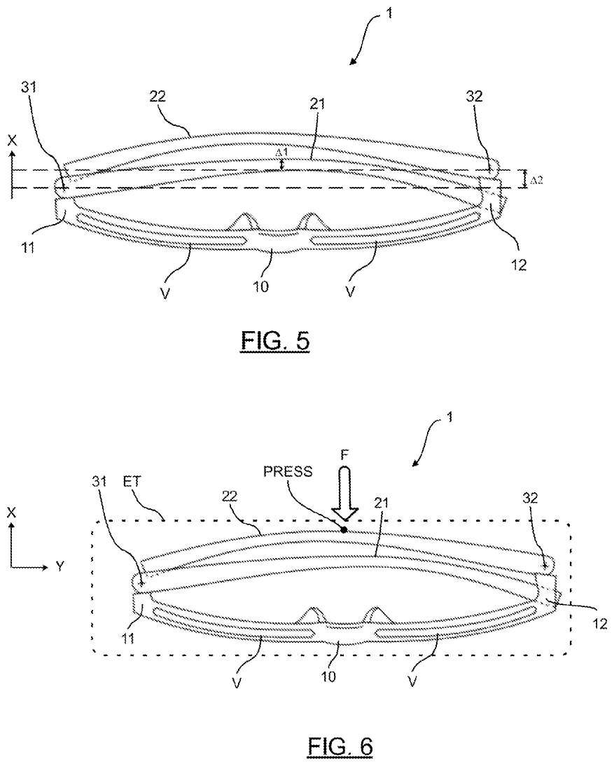

According to a preferred aspect, the first temple 21 has a determined thickness A1, in particular measured at a central point as illustrated in FIG. 5. The gap A2 between the longitudinal positions of the hinges 31, 32 is greater than said determined thickness A1 so as to avoid contact between the first temple 21 and the second temple 22. Thus, any force transmission between the second temple 22 and the first temple 21 is limited when the pair of spectacles P is folded.

Preferably, the gap A2 between the longitudinal positions of the hinges 31, 32 is comprised between 0.5 mm and 10 mm, preferably comprised between 1 mm and 7 mm, preferably still comprised between 2 mm and 5 mm. Such a range of gaps makes it possible, on the one hand, to limit the deformation of the front face 10 and, on the other hand, to limit the axial bulk of the pair of spectacles P. Such a compromise is thus optimal.

In the closed position, the first temple 21 is positioned in a first plane (parallel to XZ) while the second temple 22 is positioned in a second plane parallel and distinct from the first plane. The two planes are spaced apart by a gap corresponding to the length gap between the tenons 11, 12.

A pair of spectacles 1 has been presented in which the first tenon 11 (the shortest) is the straight tenon. Such a positioning is advantageous for right-handed people. It goes without saying that the opposite is possible.

An example of implementing a method of folding the temples 21, 22 will now be presented in reference to FIG. 4. Initially, the temples 21, 22 are in the unfolded position D, the method comprises a step of folding the first temple 21 against the front face 10 then a step of folding the second temple 22. When the two temples 21, 22 are in the folded position P, the second temple 22 is distant from the first temple 21, which makes it possible to limit the transmission of forces and, consequently, the deformation of the front face 10.

By way of example, with reference to FIG. 6, when storing the pair of spectacles P in a case ET, a longitudinal compressive force F is applied to the second temple 22 according to a pressure point PRESS without transmission to the forwardmost lateral temple (here the right temple 21) given that the temples 21, 22 are not in contact. In the manner of a damper, the temple 22, located the rearmost, absorbs the longitudinal compressive force F which is not transmitted to several points of the front face 10 and prevents its deformation.

Thanks to the invention, the service life of a pair of spectacles P is increased by reducing the risk of deformation of the front face 10. The same applies to the axes of the hinges 31, 32 which are not modified. The position of the lenses V remains optimal, which offers the wearer a long lasting optical correction over time. Finally, from an industrial point of view, the cost of such a pair of spectacles 1 is of the same order as that of a conventional pair of spectacles, i.e., with hinges 31, 32 having the same longitudinal position.

Furthermore, the invention applies to any type of hinge, for example, a conventional pivot hinge, garnet hinge or hinge allowing over-opening.

With reference to FIGS. 7 to 10, the invention also applies to a pair of spectacles of the “rimless clip on” type in which the front face 10 comprises only tenons 11, 12 attached to the lenses V and a central bridge attached to the lenses V. In other words, for such a front face, the lenses V are not mounted in circles. The invention thus applies to any type of front face 10.

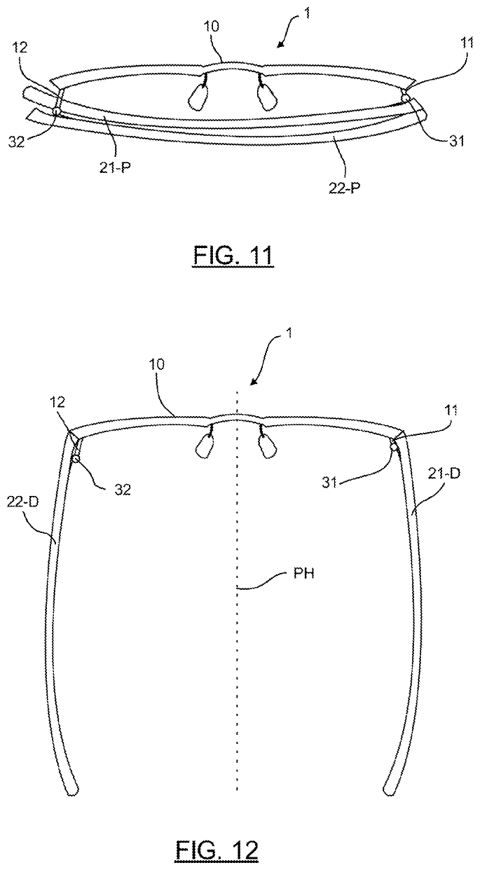

With reference to FIGS. 11 and 12, the invention also applies to a pair of spectacles 1 of which the hinges 31, 32 are offset with respect to the temples 21, 22 in the unfolded position. The hinges 31, 32 do not extend in the extension of the temples 21, 22 in the unfolded position but are offset between the temples 21, 22 in order to form staggered hinges allowing the temples 21, 22 to be directly in contact with the front face 10 in the unfolded position. This advantageously makes it possible to retain temples 21, 22 of identical lengths by offsetting the hinges 31, 32 towards the center of the pair of spectacles 1, i.e., towards a plane PH orthogonal to the front face 10 which divides it substantially symmetrically (FIG. 12). The temples 21 and 22 are identical, which facilitates industrialization.

1. A pair of spectacles, extending along a first longitudinal X-axis from the rear to the front, comprising:
a symmetrical front face comprising two lenses,
a first tenon and a second tenon which are connected to the front face,
a first temple and a second temple which are respectively connected to the first tenon and the second tenon via a first hinge and a second hinge, the first temple comprising a curvilinear portion, the second temple comprising a curvilinear portion,
wherein the gap between the longitudinal positions of the hinges is comprised between 0.5 mm and 10 mm in order to limit the risk of deformation of the front face as a result of a longitudinal compressive force.

2. The pair of spectacles according to claim 1, wherein the first tenon is shorter than the second tenon such that the longitudinal positions of the hinges are different.

3. The pair of spectacles according to one-of-claim 1, wherein the first temple having a determined thickness, the gap between the longitudinal positions of the hinges is greater than the determined thickness so as to avoid contact between the first temple and the second temple.

4. The pair of spectacles according to ene of claim 1, wherein the gap between the longitudinal positions of the hinges is comprised between 1 mm and 7 mm.

5. The pair of spectacles according to claim 1, wherein the first temple is longer than the second temple.

6. The pair of spectacles according to claim 5, wherein the assembly of the first tenon and the first temple has the same length as the assembly of the second tenon and the second temple.

7. of spectacles according to claim to 6, wherein the first temple and the second temple have the same length.

8. The pair of spectacles according to claim 7, wherein the first temple and the second temple are directly in contact with the front face (10).

9. The pair of spectacles according to claim 1, wherein the first temple is the right temple.

10. The pair of spectacles according to claim 1, wherein the first hinge and/or the second hinge is in the form of a mechanism, comprising an articulation axis, which is connected on the one hand to the front face and on the other hand to the first temple and/or the second temple.

11. A method of folding the temples of a pair of spectacles according to claim 1, the temples being in the unfolded position, the method comprising:
A step of folding the first temple against the front face then,
A step of folding the second temple, the second temple being distant from the first temple in the folded position.
